(19) United States
(12) Patent Application Publication
(10) Pub. No.: US 2017/0176226 A1
(43) Pub. Date: Jun. 22, 2017

(54) MULTI-MODE METROLOGY USER INTERFACE DEVICE

(71) Applicant: Mitutoyo Corporation, Kanagawa-ken (JP)

(72) Inventor: Matthew Raymond Dockrey, Seattle, WA (US)

(21) Appl. No.: 14/975,449

(22) Filed: Dec. 18, 2015

(51) Int. Cl. G01D 21/02

(52) U.S. Cl. CPC G01D 21/02

(57) ABSTRACT

A multi-mode metrology user interface device includes a signal processing and control portion, a user input interface portion, and a communication portion. The signal processing and control portion includes a measurement display mode configured to display measurement values from multiple metrology devices. The signal processing and control portion further includes at least one of: a) a computational mode configured to compute a value based on measurement values from multiple metrology devices; and b) a combination display mode configured to plot a graph of values from two metrology devices.

### BACKGROUND

### Technical Field

The invention relates generally to a variety of precision measurement instruments configured to communicate with each other.

### Description of the Related Art

Various manufacturing devices such as milling machines or lathes are equipped with linear scales for measuring a position of a machine tool or a workpiece. For example, Mitutoyo model AT116 or AT715 linear scales may be configured to detect an absolute position using inductive sensing and output a signal indicative of the absolute position. Such linear scales may be configured to communicate position measurements through a digital read out (DRO) system. A typical DRO system may include a digital display to show the measured position. For example, a Mitutoyo KA Counter system may be configured as part of a DRO package to display a position of a linear scale coupled with a milling machine or a lathe.

Various handheld or portable metrology tools are available such as calipers, micrometers or digital indicators, which may be configured to output data to external devices, such as a desktop computer. The data may be output through wired systems such as RS-232C communication, or wireless systems utilizing Bluetooth or other wireless communication technology. For example, a caliper such as a Mitutoyo ABS Digimatic Caliper model CD-15CX may use Mitutoyo U-WAVE wireless data communication to communicate with a computer configured with Mitutoyo MeasurLink software. Wireless connectivity may be provided by an external transmitter unit attached to a handheld or portable metrology tool. Examples of such systems are disclosed in U.S. Pat. Nos. 4,930,096 and 6,502,057.

In various applications, it may be desirable for a DRO system to have the capability to communicate with multiple metrology devices, e.g., linear scales of a machine tool as well as handheld or portable metrology tools, in order to provide speed and convenience of dimensional verification while manufacturing a workpiece. Furthermore, it may be desirable for such a DRO system to be configured for multiple modes of operation on a portable display to provide additional convenience and flexibility to an operator.

### BRIEF SUMMARY

This summary is provided to introduce a selection of concepts in a simplified form that are further described below in the Detailed Description. The summary is not intended to identify key features of the claimed subject matter, nor is it intended to be used as an aid in determining the scope of the claimed subject matter.

A multi-mode metrology user interface device includes a signal processing and control portion, a user input interface portion, and a communication portion. The signal processing and control portion includes a measurement display mode configured to display measurement values from multiple metrology devices, and at least one of:

a) a computational mode configured to compute a value based on measurement values from multiple metrology devices; and

b) a combination display mode configured to plot a graph of values from two metrology devices.

### BRIEF DESCRIPTION OF THE DRAWINGS

FIG. 1 is a block diagram of a multi-mode metrology user interface device.

FIG. 2 is a schematic diagram of a multi-mode metrology user interface device operating in a measurement mode.

FIG. 3 is a schematic diagram of the multi-mode metrology user interface device of FIG. 2, showing additional features.

FIG. 4 is a schematic diagram of a multi-mode metrology user interface device operating in a combination mode.

FIG. 5 is a schematic diagram of a multi-mode metrology user interface device operating in a computation mode.

FIG. 6 is a schematic diagram of a multi-mode metrology user interface device operating in a model interaction mode.

FIG. 7 is a schematic diagram of a multi-mode metrology user interface device operating in a setup control mode.

### DETAILED DESCRIPTION

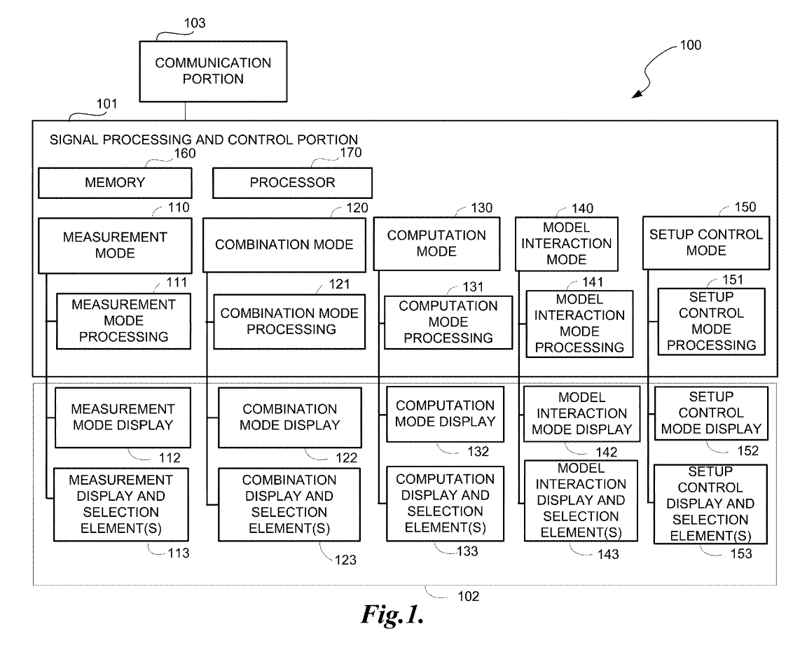

FIG. 1 is a block diagram of a multi-mode metrology user interface device 100. The multi-mode metrology user interface device 100 comprises a signal processing and control portion 101, a user input interface portion 102, and a communication portion 103.

The signal processing and control portion 101 comprises a measurement display mode 110, a combination display mode 120, a computation mode 130, a model interaction mode 140, a setup control mode 150, a memory 160, and a processor 170. The measurement mode 110 comprises measurement mode processing 111. The combination display mode 120 comprises combination display mode processing 121. The computation mode 130 comprises computation display mode processing 131. The model interaction mode 140 comprises model interaction mode processing 141. The setup control mode 150 comprises setup control mode processing 151.

The user input interface portion 102 comprises a measurement mode display 112, a combination mode display 122, a computation mode display 132, a model interaction mode display 142, and a setup control mode display 152. The measurement mode display 112 comprises measurement display and selection elements 113. The combination mode display 122 comprises combination display and selection elements 123. The computation mode display 132 comprises computation display and selection elements 133. The model interaction mode display 142 comprises model interaction display and selection elements 143. The setup control mode display 152 comprises setup control display and selection elements 153.

The communication portion 103 may be configured to communicate with multiple types of metrology devices through various wireless communication means such as Bluetooth, Wi-Fi, and cloud based data infrastructure.

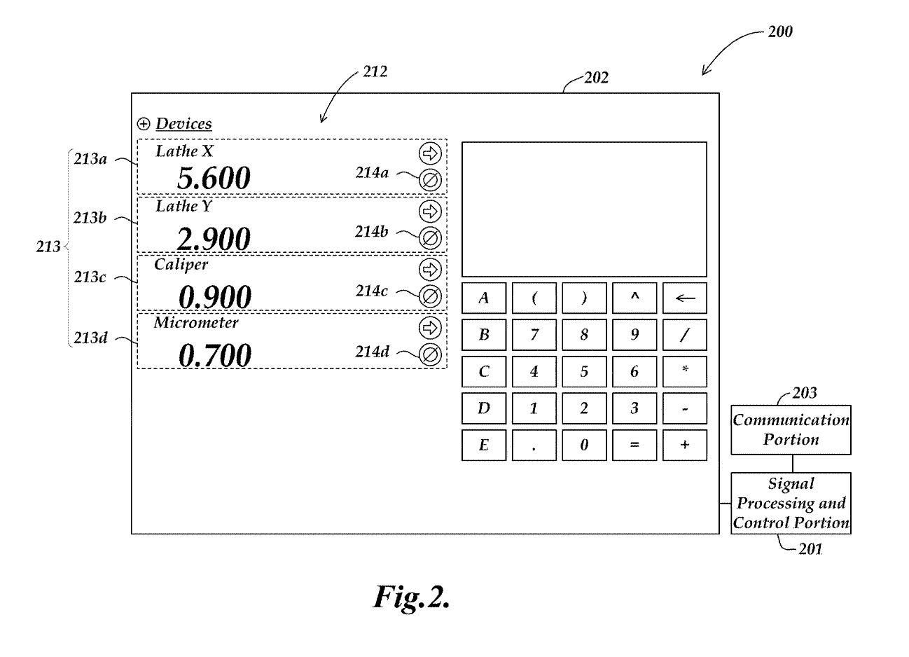

The multi-mode metrology user interface device 100 provides a convenient and versatile means of displaying and interacting with data from multiple metrology sources in multiple modes as outlined in FIGS. 2-7.

FIG. 2 is a schematic diagram of a multi-mode metrology user interface device 200 operating in a measurement mode (e.g., measurement mode 110) which comprises measurement mode processing (e.g., measurement mode processing 111). The multi-mode metrology user interface device 200 is similar or identical to the multi-mode metrology user interface device 100. The multi-mode metrology user interface device 200 comprises a control portion 201, a user input interface portion 202, and a communication portion 203.

The user input interface portion 202 comprises a measurement mode display 212. The measurement mode display 212 comprises measurement display and selection elements 213.

The measurement mode 110 is configured to display measurement values from multiple metrology devices in the user input interface portion 202. More specifically, the measurement mode display 212 is configured to display measurements from multiple types of metrology devices such as lathes, calipers, micrometers or other metrology devices. As shown in FIG. 2, the measurement display and selection elements 213 comprise a lathe X measurement display and selection element 213a, a lathe Y measurement display and selection element 213b, a caliper measurement display and selection element 213c, and a micrometer display and selection element 213d which are each configured to display measurement values from their respective metrology devices. The lathe X measurement display and selection element 213a, the lathe Y measurement display and selection element 213b, the caliper measurement display and selection element 213c, and the micrometer display and selection element 213d each comprise respective zero setting selection elements 214a, 214b, 214c, 214d which are configured to set the measurement values to zero. This may assist a user in determining relative positions for a cut, for example, when operating a lathe tool.

In some embodiments, the multi-mode metrology user interface device 200 may comprise a touch screen, for example, on a tablet device. In some embodiments, the touch screen may be portable and the communication portion 203 may be configured with wireless communication (e.g., Bluetooth technology) in order to provide a convenient user interface that may be moved around a working environment.

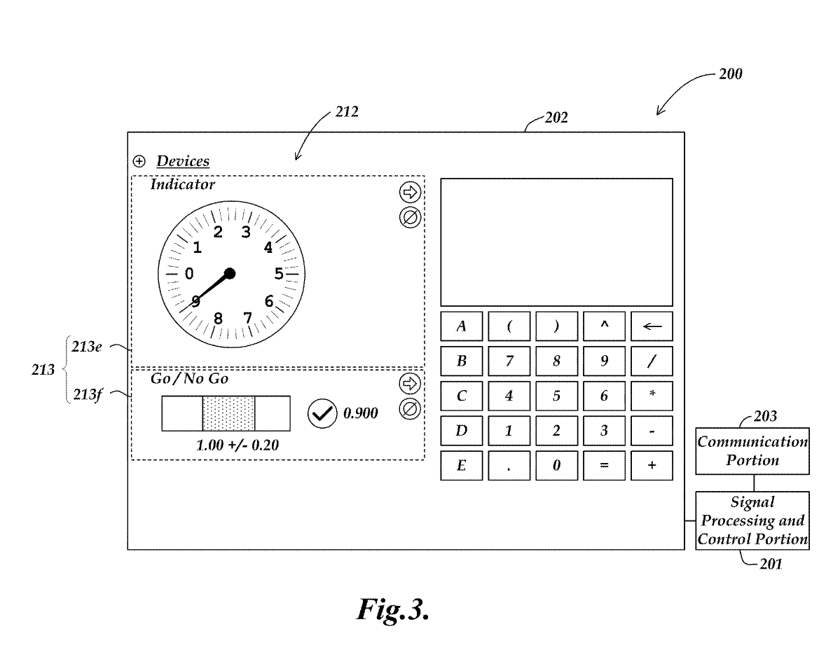

FIG. 3 is a schematic diagram of the multi-mode metrology user interface device 200 of FIG. 2, showing additional features. As shown in FIG. 3, the multi-mode metrology user interface device 200 additionally comprises an indicator display and selection element 213e and a tolerance range display element 213f. The indicator display and selection element 213e provides a display configured according to the structure of an analog dial indicator, which shows an analog representation of a measurement taken by an indicator. The tolerance range display element 213f shows whether a measurement is within a specified tolerance, i.e., in order to provide a “go/no go” inspection tool. As shown in FIG. 3, the tolerance range display element 213f is configured to input the same indicator signal as the indicator selection element 213e. The tolerance range display element 213f shows that a measurement of 0.900 mm is within a tolerance range of 1.00+/−0.20 mm, as indicated by a checkmark in a circle. In some embodiments, the checkmark may be displayed in a green circle. If a measurement is not within the tolerance range the tolerance range display element 213f may be configured to display an X in a red circle. It should be appreciated that other types of customized “go/no go” inspection tools may be provided by the multi-mode metrology user interface device 200. For example, two indicators may be used to measure a step height which may be displayed for a specified tolerance using a similar tolerance range display element.

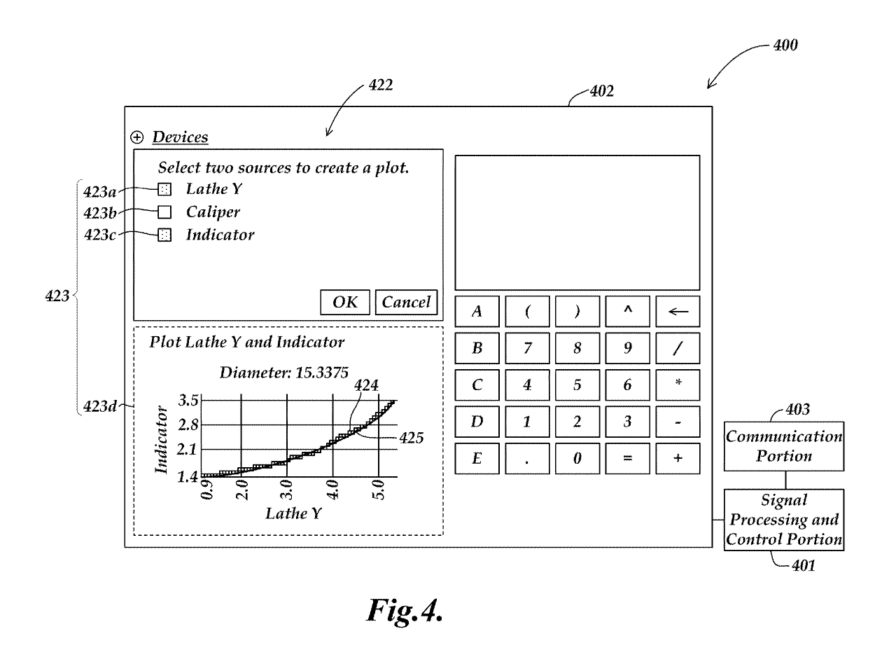

FIG. 4 is a schematic diagram of a multi-mode metrology user interface device 400 operating in a combination mode (e.g., combination mode 120) which comprises combination mode processing (e.g., combination mode processing 121). The multi-mode metrology user interface device 400 is similar or identical to the multi-mode metrology user interface device 100. The multi-mode metrology user interface device 400 comprises a control portion 401, a user input interface portion 402 and a communication portion 403.

The user input interface portion 402 comprises a combination mode display 422. The measurement mode display 422 comprises combination display and selection elements 423. The combination display and selection elements 423 comprise a lathe Y display and selection element 423a, a caliper display and selection element 423b, an indicator display and selection element 423c, and a plot display element 423d.

The combination mode is configured to plot a graph of values from two metrology devices which may be selected by the combination display and selection elements 423. More specifically, the plot display element 423d is configured to show a graph of indicator values corresponding to lathe Y positions. A user may mount an indicator on a lathe carriage such that it is positioned to engage a workpiece, and move the lathe carriage while the multi-mode metrology user interface device 400 receives lathe Y signals and indicator signals through the communication portion 403, which may then be displayed as a set of coordinates 424 in the plot display element 423d.

In some embodiments, the combination mode may be configured to perform curve or line fitting. For example, a curve fit 425 may be applied to the set of coordinates 424 as shown in the plot display element 423d. The curve fit 425 may be utilized to determine a diameter of a round workpiece feature. The plot display element 423d shows a diameter of 15.3375 mm.

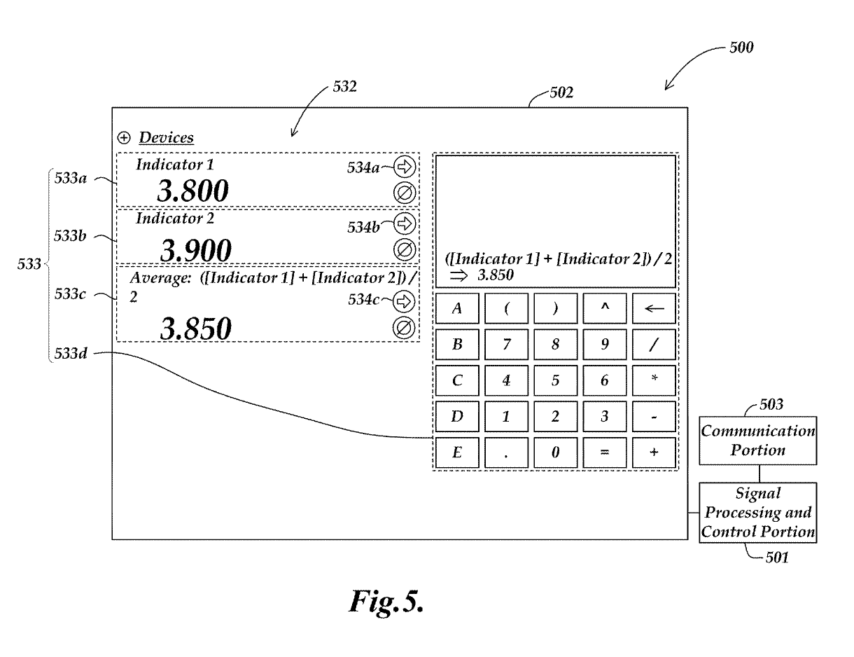

FIG. 5 is a schematic diagram of a multi-mode metrology user interface device 500 operating in a computation mode (e.g., computation mode 130) which comprises computation mode processing (e.g., computation mode processing 131). The multi-mode metrology user interface device 500 is similar or identical to the multi-mode metrology user interface device 100. The multi-mode metrology user interface device 500 comprises a control portion 501, a user input interface portion 502 and a communication portion 503.

The user input interface portion 502 comprises a computation mode display 532. The computation mode display 532 comprises computation display and selection elements 533. The computation display and selection elements 533 comprise a first indicator computation display and selection element 533a, a second indicator computation display and selection element 533b, an average computation display and selection element 533c, and a computation calculator display and selection element 533d. Each of the first indicator computation display and selection element 533a, the second indicator computation display and selection element 533b, and the average computation display and selection element 533c comprises respective value input buttons 534a, 534b, 534c.

A user may construct a formula using the computation calculator display and selection element 533d which may input values the user selects by using the value input buttons 534a, 534b, 534c. For example, a user may select the first indicator computation display and selection element 533a and the second indicator computation display and selection element 533b as values to be averaged. By selecting the value input button 534a, a value “[Indicator 1]” appears in the computation calculator display and selection element 533d which represents a value input by the first indicator computation display and selection element 533a from a first electronic indicator. By selecting the value input button 534b, a value “[Indicator 2]” appears in the computation calculator display and selection element 533d which represents a value input by the second indicator computation display and selection element 533b from a second electronic indicator. The formula and result for this average may then be displayed, for example, by the average computation display and selection element 533c. The result may also be used as a “virtual” data source in a similar manner to the values of the first indicator computation display and selection element 533a and the second indicator computation display and selection element 533b.

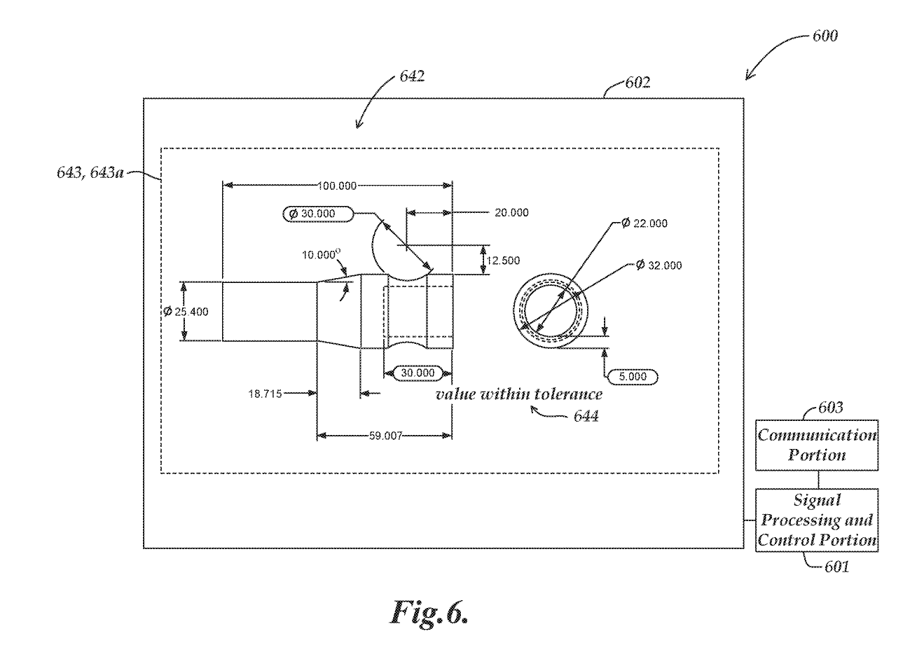

FIG. 6 is a schematic diagram of a multi-mode metrology user interface device 600 operating in a model interaction mode (e.g., model interaction mode 140) which comprises model interaction mode processing (e.g., model interaction mode processing 141). The multi-mode metrology user interface device 600 is similar or identical to the multi-mode metrology user interface device 100. The multi-mode metrology user interface device 600 comprises a control portion 601, a user input interface portion 602, and a communication portion 603.

The user input interface portion 602 comprises a model interaction mode display 642. The computation mode display 642 comprises model interaction display and selection elements 643. The model interaction display and selection elements 643 comprise a model display and selector element 643a. The model display and selection element 643a may be configured to input a model of a workpiece. In various embodiments, the model may be a 2D drawing or a CAD model of the workpiece. A user may add an annotation to the model, such as a note of “value within tolerance” 644 or an actual value from a measurement input by the communication portion 603. An annotation may be added, for example, through a touchscreen keypad or a voice input.

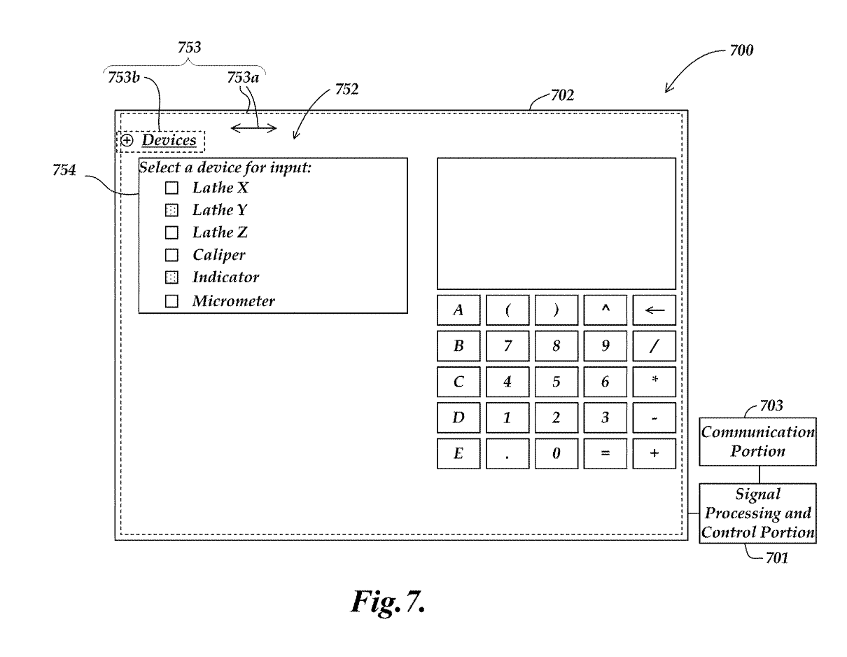

FIG. 7 is a schematic diagram of a multi-mode metrology user interface device 700 operating in a setup control mode (e.g., setup control mode 150) which comprises setup control mode processing (e.g., setup control mode processing 151). The multi-mode metrology user interface device 700 is similar or identical to the multi-mode metrology user interface device 100. The multi-mode metrology user interface device 700 comprises a control portion 701, a user input interface portion 702, and a communication portion 703.

The user input interface portion 702 comprises a setup control mode display 752. The setup control mode display 752 comprises setup control display and selection elements 753. The setup control display and selection elements 753 comprise a mode selection element 753a and a metrology device selection element 753b. The mode selection element 753a may be used to select a mode in which the multi-mode metrology user interface device 700 will operate (e.g., measurement mode 110, combination mode 120, computation mode 130, or model interaction mode 140). In the embodiment shown in FIG. 7, the entirety of the setup control mode display 752 may be used for the mode selection element 753a by responding to a swipe gesture left or right to scroll through available modes. It should be appreciated that this is exemplary only and not limiting and many alternative selection structures may be utilized for the mode selection element 753a such as a drop down menu or a list box. The metrology device selection element 753b may be used to select one or more metrology tools from which the communication portion 703 may input measurement data. In some embodiments, the metrology device selection element 753b may comprise an area marked “devices” which a user may hold to bring forth a device selection menu 754 which shows metrology devices which are available for input to the multi-mode metrology user interface device 700.

Various embodiments described above can be combined to provide further embodiments. All of the U.S. patents and U.S. patent applications referred to in this specification are incorporated herein by reference, in their entirety. Aspects of the embodiments can be modified, if necessary to employ concepts of the various patents and applications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled.

The embodiments of the invention in which an exclusive property or privilege is claimed are defined as follows:

1. A multi-mode metrology user interface device, comprising:
a signal processing and control portion;
a user input interface portion; and
a communication portion,
wherein:
the signal processing and control portion comprises:
a measurement display mode configured to display measurement values from multiple metrology devices; and
at least one of:
a) a computation mode configured to compute a value based on measurement values from multiple metrology devices; and
b) a combination display mode configured to plot a graph of values from two metrology devices.

2. The multi-mode metrology user interface device of claim 1 wherein the user input interface portion comprises a measurement mode display comprising measurement display and selection elements configured to display measurement values from multiple metrology devices.

3. The multi-mode metrology user interface device of claim 1 wherein the signal processing and control portion comprises the computational mode, and the user input interface portion comprises a computation mode display comprising computation mode display and selection elements configured to display a value which is computed based on measurement values from multiple metrology devices.

4. The multi-mode metrology user interface device of claim 1 wherein the signal processing and control portion comprises the combination mode, and the user input interface portion comprises a combination mode display comprising combination mode display and selection elements configured to select measurement values and plot a graph of values from two metrology devices.

5. The multi-mode metrology user interface device of claim 1 wherein the combination mode is configured to perform curve or line fitting.

6. The multi-mode metrology user interface device of claim 1 wherein the measurement display mode comprises a tolerance range display element configured to show whether a measurement is within a specified tolerance.

7. The multi-mode metrology user interface device of claim 1 wherein the measurement display mode is configured to display an analog dial indicator which shows an analog representation of a measurement taken by an indicator.

8. The multi-mode metrology user interface device of claim 1, further comprising a model interaction mode, and the user input interface portion comprises a model interaction mode display comprising combination mode display and selection elements which are configured to display a model corresponding to a workpiece.

9. The multi-mode metrology user interface device of claim 8 wherein the model interaction mode is configured to add annotations to the model.

10. The multi-mode metrology user interface device of claim 1, further comprising a setup control mode, wherein the user input interface portion comprises a setup control mode display comprising setup control mode display and selection elements configured to select a mode in which the multi-mode metrology user interface device will operate and to select one or more metrology tools from which the communication portion may input measurement data.

11. The multi-mode metrology user interface device of claim 1 wherein the user input interface portion comprises a portable display.

12. The multi-mode metrology user interface device of claim 11 wherein the portable display is a touch screen tablet device.

13. The multi-mode metrology user interface device of claim 1 wherein the communication portion is configured to communicate with multiple types of metrology devices through wireless communication.
